(19) United States
(12) Patent Application Publication
(10) Pub. No.: US 2007/0053385 A1
(43) Pub. Date: Mar. 8, 2007

(54) Cascade switch for network traffic aggregation

(75) Inventor: S. Cullen Tollbom, Richland, WA (US)

Correspondence Address: Douglas E. McKinley, Jr., P.O. Box 202, Richland, WA, 99352, US

(73) Assignee: Battelle Memorial Institute

(21) Appl. No.: 11/221,564

(22) Filed: Sep. 7, 2005

(51) Int. Cl. H04J 3/02

(52) U.S. Cl. 370/537

(57) ABSTRACT

A method and apparatus for aggregating network traffic using “cascade” of individual nodes, where each node connected to, and configured to monitor, two or more nodes below it. Each node has two or more inputs. These inputs are connected to a CPU having a memory buffer to temporarily store the network data streams from the inputs, and an outlet port capable of transferring network data streams from the memory buffer and the CPU to an output network. The CPU is thus connected to the inputs, the memory buffer and the outlet port, and serves to transfer network data streams from the inputs to the memory buffer, and to simultaneously transmit the network data streams from the memory buffer to the outlet port. Nodes that gather network data streams directly from the network have two or more network controllers, each of which are connected to the network to receive network data streams from the network, and also connected to the node inputs to transfer data to the CPU and the memory buffer.

The invention was made with Government support under Contract DE-AC0576RLO 1830, awarded by the U.S. Department of Energy. The Government has certain rights in the invention.

### TECHNICAL FIELD

This invention relates to methods for aggregating and monitoring network traffic. More specifically, this invention relates to low cost methods for aggregating network traffic into a common feed using a novel arrangement of inexpensive, off-the-shelf components.

### BACKGROUND OF THE INVENTION

Most, if not all, large organizations which provide internet connections to a large number of users have a continuing need to monitor the traffic between their internal network and the outside world. Typically, network traffic is not monitored directly. Instead, to allow the traffic to flow to and from users unimpeded, a reproduction of the traffic is made. Often, to be comprehensive, capturing this reproduction at different locations throughout the network. Several reproductions are then combined and analyzed.

Thus, as organizations add users and traffic to their networks, new equipment must be added to capture traffic on these networks, and this new equipment must be capable of keeping up with ever increasing volumes of data. The equipment to capture, reproduce, and combine these data flows can be expensive. Network administrators in large organizations everywhere have this same ultimate problem, and the need for a method to aggregate and reproduce network traffic using low cost equipment is widespread and pervasive. Thus, there exists a need for a solution that allows network administrators to aggregate and reproduce the network traffic while minimizing equipment cost.

### SUMMARY OF THE INVENTION

Accordingly, one object of the present invention is to provide a method and system to aggregate, reproduce and monitor network traffic. It is a further object of the present invention to provide a method and system to aggregate and reproduce network traffic at the lowest possible equipment cost. It is yet a further object of the present invention to provide a method and system to aggregate and reproduce network traffic using off-the-shelf components. These and other objects of the present invention are accomplished by providing a system and method for aggregating multiple sources of network traffic into a common feed.

The present invention achieves these objects by forming a “cascade” of individual nodes, where each node connected to, and configured to monitor, two or more nodes below it. The basic building block of the present invention is therefore a node. Nodes that gather network data streams directly from the network have two or more network controllers, each of which are connected to the network to receive network data streams from the network. The network controllers are also connected to two or more inputs. These inputs are connected to a CPU having a memory buffer to temporarily store the network data streams from the inputs, and an outlet port capable of transferring network data streams from the memory buffer and the CPU to an output network. The CPU is thus connected to the inputs, the memory buffer and the outlet port, and serves to transfer network data streams from the inputs to the memory buffer, and to simultaneously transmit the network data streams from the memory buffer to the outlet port.

Nodes that are not connected directly to the network are thus used to combine network data streams downstream nodes. Accordingly, nodes that are not connected to the network do not need network controllers. Instead, these nodes simply connect their inputs to the outlets of nodes that are connected to the network.

Accordingly, a simple cascade is formed by a first and second node, wherein each of the first and second nodes are connected to a network using network controllers as described above. A third node is then connected to the first and second nodes, wherein the third node has two or more inputs, each connected to one of the outlet ports of the first and second nodes. As with the first and second nodes, the third node has a memory buffer to temporarily store network data streams from the inputs, a final outlet port capable of transferring network data streams from the memory buffer and a CPU to an output network, and a CPU connected to the inputs, the memory buffer and the final outlet port. The CPU is configured to transfer the network data streams from the inputs to the memory buffer, and simultaneously transmit the network data streams from the memory buffer to the final outlet port.

An additional node can then be used to combine two or more simple cascades in the same manner as is used to combine the first and second nodes. In this manner, successive layers of nodes can be added, each forming an additional layer in a pyramid of nodes, all feeding network data streams to the top node. By way of example, and not meant to be limiting, a cascade might have 16 nodes communicating with the network and transferring network data streams from the network to a set of 8 nodes, which in turn transfer the network data streams to a set of 4 nodes, which in turn transfer the network data streams to a set of 2 nodes, which in turn transfer the network data streams to a single node, which then transfers the network data streams to an output network.

To illustrate the arrangement of the present invention, a simple cascade is shown in FIG. 1. As shown in the figure, each node 1 consists of a CPU 2 in communication with memory 3. Each node is preferably provided simply as an inexpensive off-the-shelf personal computer, which has been configured to interface with network data streams through two or more inputs 4. For nodes 1 in communication with the network that is being monitored, these inputs are interfaced with two or more network controllers 5, which are in turn in communication with the network data streams 6. For nodes 8 that are in communication only with other nodes 1, these inputs 4 are simply interfaced with the outlet ports 7 of other nodes 1. Thus configured, the CPU 2 is interfaced with the network controllers 5 to process network data streams 6 captured by the input controllers 5.

In each node, a memory buffer 3 is further provided to temporarily store data. An outlet port 7 capable of transferring data from the memory buffer 3 and the CPU 2 to an output network 9 or another node 8, and the CPU 2 is configured to transfer data from the inputs 4 to the memory buffer 3, and simultaneously transmit data from the memory buffer 3 to the outlet port 7.

Aggregated network data streams sent to output network 9 may be analyzed in a variety of ways. For example, and not meant to be limiting, output network 9 could include a multiple port repeating tap 10, to which security sensors 11 and network diagnostic equipment 12 can be attached.

As used herein, the term “simultaneously” should be understood to encompass typical configurations where a CPU tasks the data bus and memory to perform two or more different processes at the same time, including configurations where it does so by performing these processes sequentially, in parallel, or by rapidly switching back and forth between the processes, a process often referred to by those having skill in the art as “quantum scheduling.” Accordingly, as used herein, “simultaneous” transmissions include, but are not limited to, transmissions that are actually sequential or alternating, but which appear to be simultaneous, as the CPU rapidly switches between them.

### BRIEF DESCRIPTION OF THE DRAWINGS

FIG. 1 is a block diagram of a simple cascade of the present invention.

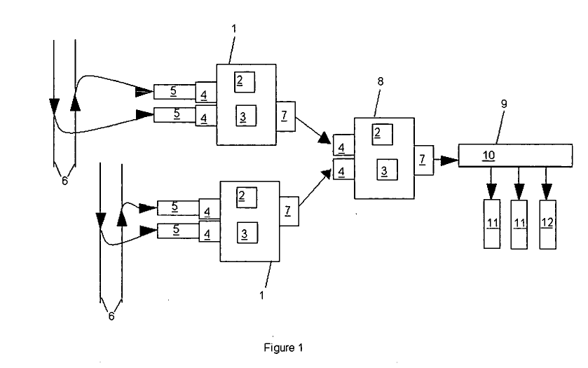

### DETAILED DESCRIPTION OF THE PREFERRED EMBODIMENTS

As with many inventions, the present invention was initially conceived as a result of a specific problem confronted by the inventor. While this problem and its solution are described below in detail, those having ordinary skill in the art will recognize that the invention should not be limited in anyway to the specific embodiment described herein. Rather, those having ordinary skill in the art will readily recognize and appreciate that the present invention is generally applicable to any computer network, and the specific embodiment set forth below is merely illustrative of the present invention's utility in one such environment.

The present invention was conceived as a solution for monitoring network traffic on a network that provides Internet connectivity to approximately three thousand internal users. This network was configured with 4 channelized Gigabit Ethernet connections between two perimeter routers and an array of network Firewalls. Within this network, a total of five Gigabit Ethernet sensors were attached to the various monitoring ports of the perimeter routers. Because the perimeter routers supported one or two monitor ports each, sensing traffic from Gigabit Ethernet, OC3 and OC12 ATM interfaces in the same routers often failed as no single sensor could see all of the data entering or exiting the perimeter to or from the firewall array.

One proposed solution to this problem was to optically tap the 4 channelized Gigabit Ethernet connections, 4 upstream and 4 downstream, for 8 gigabit streams total. However, that would mean 40 (8×5) sensors and 4 repeating optical taps would be required. The equipment costs of this proposed solution were prohibitively expensive.

Instead, an array of 7 nodes, (four feeding to two feeding to one) each consisting of a Dell 2650 computer (Dell Inc., Round Rock, Tex.) with 4 GB of memory were placed an array. Each of these computers was equipped with with three optical or copper Intel Pro/1000 MF Gigabit Ethernet interfaces (Intel Inc., Santa Clara, Calif.), which served as the input ports and the outlet port for each node. Four of these nodes were further connected to a set of 4 network controllers; Netoptics Gigabit Fiber Taps P/N: 96042-G (SX) (Netoptics Inc., Sunnyvale, Calif.), each tapping both the inbound and outbound Internet traffic carried on the 4 channelized Gigabit Ethernet circuits between the routers and the firewalls. As such that there were 8 optical gigabit streams total, 4 upstream and 4 downstream, between the 4 nodes, the routers, and the firewalls.

These 4 nodes were then connected to, and monitored by, two upstream nodes, which were in turn connected to, and monitored by, a final node. The final node was then connected to an output network consisting of a NetOptics 8×1 Gigabit Regeneration Tap P/N: 96282-8 (SX) (NetOptics, Sunnyvale, Calif.) 8-port repeating tap, to which security sensors and network diagnostic equipment were attached. In this prototype configuration, traffic aggregation was 8:1.

Each of the nodes was configured to run the Linux operating system with slight modifications. While not meant to be limiting, this embodiment used the RedHat Linux 2.4.20-13.9 kernel. The kernel's bridge module and configuration management and control program, brctl, were modified to support a new port type—a monitor port, and all incoming traffic is redirected to the monitor port. The kernel was also retuned to allow large amounts of system memory to be used for buffering packets inside the bridge, to minimize loss.

While not meant to be limiting, the source code for the specific modifications to Linux used in this embodiment are shown in the code that follows. As will be recognized by those having ordinary skill in the art, the source code for the RedHat Linux 2.4.20-13.9 kernel may be modified to incorporate the code shown below by using the “patch” utility command.

!Cascade Linux 2.4.20-13.9 Kernel Modifications
!
! br_private.h (Data Structures)
!
% diff cascade/br_private.h /usr/src/linux-2.4/net/bridge/br_private.h
85d84
< struct net_bridge_port *monitor;
156,158d154
< extern void br_monitor(struct net_bridge *br,
< struct sk_buff *skb,
< int clone);
164,165c160
< struct net_device *dev,
< int mode);
---
> struct net_device *dev);
!
! br_forward.c (Packet Forwarding & Output)
!
% diff cascade/br_forward.c /usr/src/linux-2.4/net/bridge/br_forward.c
26,27c26
< if (p->br->monitor != NULL ||
< skb->dev == p->dev ||
---
> if (skb->dev == p->dev ||
150,166d148
<
< /* called under bridge lock */
< void br_monitor(struct net_bridge *br, struct sk_buff *skb, int clone)
< {
< if (clone) {
< struct sk_buff *skb2;
<
< if ((skb2 = skb_clone(skb, GFP_ATOMIC)) == NULL) {
< br->statistics.tx_dropped++;
< return;
< }
<
< skb = skb2;
< }
< _br_forward(br->monitor, skb);
< return;
< }
!
! br_if.c (Interface Handler)
!
% diff cascade/br_if.c /usr/src/linux-2.4/net/bridge/br_if.c
65,67d64
< if (br->monitor == p)
< br->monitor = NULL;
<
124,125c121
< br->stp_enabled = 0;
< br->monitor = NULL;
---
> br->stp_enabled = 1;
226c222
< int br_add_if(struct net_bridge *br, struct net_device *dev, int mode)
---
> int br_add_if(struct net_bridge *br, struct net_device *dev)
247,249d242
< if (mode != 0)
< br->monitor = p;
<
!
! br_input.c (Packet Input)
!
% diff cascade/br_input.c /usr/src/linux-2.4/net/bridge/br_input.c
79,85d78
< if (br->monitor != NULL) {
< br_monitor(br, skb, !passedup);
< if (!passedup)
< br_pass_frame_up(br, skb);
< goto out;
< }
<
139,145d131
< if (br->monitor != NULL) {
< NF_HOOK(PF_BRIDGE, NF_BR_PRE_ROUTING,
skb, skb->dev, NULL,
< br_handle_frame_finish);
< read_unlock(&br->lock);
< return;
< }
<
!
! br_ioctl.c (Input/Output Control)
!
% diff cascade/br_ioctl.c /usr/src/linux-2.4/net/bridge/br_ioctl.c
44c44
< ret = br_add_if(br, dev, arg1);
---
> ret = br_add_if(br, dev);
!---------------------------------------------------------------------------------
!Control Program Modifications
!
! brctl.c (Cascade Bridge Control Utility)
!
! based on version 0.9.3
!
% diff cascade/brctl.c /usr/src/bridge-utils/brctl/brctl.c
30c30
< “\taddif\t\t<bridge> <device> [monitor]\tadd interface to bridge\n”
---
> “\taddif\t\t<bridge> <device>\tadd interface to bridge\n”
86c86,88
< return cmd->func(br, argv[argindex], argv[argindex+1]);
---
> cmd->func(br, argv[argindex], argv[argindex+1]);
>
> return 0;
!
! brctl.h (Data Structures and Function Definitions)
!
% diff cascade/brctl.h /usr/src/bridge-utils/brctl/brctl.h
26c26
< int (*func)(struct bridge *br, char *arg0, char *arg1);
---
> void (*func)(struct bridge *br, char *arg0, char *arg1);
!
! brctl_cmd.c (Cascade Bridge Control Utility Command Functions)
!
% diff cascade/brctl_cmd.c /usr/src/bridge-utils/brctl/brctl_cmd.c
28c28
< int br_cmd_addbr(struct bridge *br, char *brname, char *arg1)
---
> void br_cmd_addbr(struct bridge *br, char *brname, char *arg1)
33c33
< return 0;
---
> return;
45d44
< return err;
48c47
< int br_cmd_delbr(struct bridge *br, char *brname, char *arg1)
---
> void br_cmd_delbr(struct bridge *br, char *brname, char *arg1)
53c52
< return 0;
---
> return;
70d68
< return err;
73c71
< int br_cmd_addif(struct bridge *br, char *ifname, char *arg1)
---
> void br_cmd_addif(struct bridge *br, char *ifname, char *arg1)
77d74
< int mode;
82c79
< return ENODEV;
---
> return;
85,95c82,83
< mode = 0;
<
< if (arg1 != NULL)
< {
< if ((strcmp(arg1,“monitor”) == 0) ||
< (strcmp(arg1,“1”) == 0))
< mode = 1;
< }
<
< if ((err = br_add_interface(br, ifindex, mode)) == 0)
< return 0;
---
> if ((err = br_add_interface(br, ifindex)) == 0)
> return;
108d95
< return err;
111c98
< int br_cmd_delif(struct bridge *br, char *ifname, char *arg1)
---
> void br_cmd_delif(struct bridge *br, char *ifname, char *arg1)
119c106
< return ENODEV;
---
> return;
123c110
< return 0;
---
> return;
135d121
< return err;
138c124
< int br_cmd_setageing(struct bridge *br, char *time, char *arg1)
---
> void br_cmd_setageing(struct bridge *br, char *time, char *arg1)
147d132
< return 0;
150c135
< int br_cmd_setbridgeprio(struct bridge *br, char *_prio, char *arg1)
---
> void br_cmd_setbridgeprio(struct bridge *br, char *_prio, char *arg1)
156d140
< return 0;
159c143
< int br_cmd_setfd(struct bridge *br, char *time, char *arg1)
---
> void br_cmd_setfd(struct bridge *br, char *time, char *arg1)
168d151
< return 0;
171c154
< int br_cmd_setgcint(struct bridge *br, char *time, char *arg1)
---
> void br_cmd_setgcint(struct bridge *br, char *time, char *arg1)
180d162
< return 0;
183c165
< int br_cmd_sethello(struct bridge *br, char *time, char *arg1)
---
> void br_cmd_sethello(struct bridge *br, char *time, char *arg1)
192d173
< return 0;
195c176
< int br_cmd_setmaxage(struct bridge *br, char *time, char *arg1)
---
> void br_cmd_setmaxage(struct bridge *br, char *time, char *arg1)
204d184
< return 0;
207c187
< int br_cmd_setpathcost(struct bridge *br, char *arg0, char *arg1)
---
> void br_cmd_setpathcost(struct bridge *br, char *arg0, char *arg1)
214c194
< return ENODEV;
---
> return;
219d198
< return 0;
222c201
< int br_cmd_setportprio(struct bridge *br, char *arg0, char *arg1)
---
> void br_cmd_setportprio(struct bridge *br, char *arg0, char *arg1)
229c208
< return ENODEV;
---
> return;
234d212
< return 0;
237c215
< int br_cmd_stp(struct bridge *br, char *arg0, char *arg1)
---
> void br_cmd_stp(struct bridge *br, char *arg0, char *arg1)
246d223
< return 0;
249c226
< int br_cmd_showstp(struct bridge *br, char *arg0, char *arg1)
---
> void br_cmd_showstp(struct bridge *br, char *arg0, char *arg1)
252d228
< return 0;
255c231
< int br_cmd_show(struct bridge *br, char *arg0, char *arg1)
---
> void br_cmd_show(struct bridge *br, char *arg0, char *arg1)
267d242
< return 0;
286c261
< int _dump_fdb_entry(struct fdb_entry *f)
---
> void _dump_fdb_entry(struct fdb_entry *f)
295d269
< return 0;
298c272
< int br_cmd_showmacs(struct bridge *br, char *arg0, char *arg1)
---
> void br_cmd_showmacs(struct bridge *br, char *arg0, char *arg1)
321d294
< return 0;

While the embodiment described above serves to demonstrate the operability of the present invention in the specific network environment confronting the inventors, those having ordinary skill in the art will readily recognize that the present invention is equally operable in other environments. For example, while the embodiment described above utilized computers running the Linux operating system, any operating system could be modified to operate as described above. Further, alternate arrangements of the nodes are possible.

For example, and not meant to be limiting, the Net Optics Multi-port Tap is capable of handling two 1 Gigabit Ethernet streams (1 upstream, 1 downstream). Accordingly, the nodes of the present invention could easily be rearranged in a dual 2-monitored-by-1 configuration, (two separate simple cascades) with one set of nodes aggregating upstream, or incoming traffic, and one aggregating downstream, or outgoing traffic, making traffic aggregation 8:2. One would expect this arrangement would increase the performance up to 2 Gigabits per second while reducing the number of nodes from 7 to 6. As will be recognized by those having ordinary skill in the art, in this type of arrangement the security sensors would need to be modified to handle the separated streams.

Additionally, the present invention can be used to convert and aggregate traffic from different media (for example, Ethernet, Fast Ethernet, FDDI, 1 Gigabit Ethernet, 10 Gigabit Ethernet) to common sensor systems. In this type of arrangement, lossless, mixed media configurations are possible. For example, the outer nodes could be monitoring up to 100 Ethernet or 10 Fast Ethernet span ports from switches, or the interior interfaces could be swapped out with 10 Gigabit Ethernet interfaces.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

The invention claimed is:

1. A method for aggregating multiple sources of network data streams into a common feed comprising:
providing two or more network controllers, said network controllers connected to a network for receiving said network data streams from said network,
providing two or more inputs, each of said inputs connected to each of said network controllers,
providing a memory buffer to temporarily store said network data streams from said inputs,
providing an outlet port capable of transferring network data streams from said memory buffer and a CPU to an output network, and
providing a CPU connected to said inputs, said memory buffer and said outlet port to transfer said network data streams from said inputs to said memory buffer, and simultaneously transmit said network data streams from said memory buffer to said outlet port.

2. The method of claim 1 wherein the CPU is provided with a version of the Linux operating system modified to support a monitor port and all incoming traffic is redirected to the monitor port.

3. The method of claim 1 wherein the network controllers are configured to receive network data streams from Ethernet, Fast Ethernet, FDDI, 1 Gigabit Ethernet, 10 Gigabit Ethernet, and combinations thereof.

4. A method for aggregating multiple sources of network data streams into a common feed comprising:
providing a first and second node, wherein each of said first and second nodes have
two or more network controllers, said network controllers connected to a network for receiving said network data streams from said network,
two or more inputs, each of said inputs connected to each of said network controllers,
a memory buffer to temporarily store said network data streams from said inputs,
an outlet port capable of transferring network data streams from said memory buffer and a CPU to an output network, and
a CPU connected to said inputs, said memory buffer and said outlet port to transfer said network data streams from said inputs to said memory buffer, and simultaneously transmit said network data streams from said memory buffer to said outlet port,
providing a third node connected to said first and second nodes, wherein said third node has:
two or more inputs, each input connected with one of said outlet ports of said first and second nodes,
a memory buffer to temporarily store network data streams from said inputs,
a final outlet port capable of transferring network data streams from said memory buffer and a CPU to an output network, and
a CPU connected to said inputs, said memory buffer and said final outlet port to transfer said network data streams from said inputs to said memory buffer, and simultaneously transmit said network data streams from said memory buffer to said final outlet port.

5. The method of claim 4 wherein each of the CPUs of the first, second and third nodes are provided with a version of the Linux operating system modified to support a monitor port and all incoming traffic is redirected to the monitor port.

6. The method of claim 4 wherein the network controllers are configured to receive network data streams from Ethernet, Fast Ethernet, FDDI, 1 Gigabit Ethernet, 10 Gigabit Ethernet, and combinations thereof.

7. The method of claim 4 wherein the network controllers of the first node are configured to receive upstream network data streams and the network controllers of the second node are configured to receive downstream data streams.

8. The method of claim 4 wherein the one of each of the network controllers of the first and second nodes are configured to receive upstream network data streams and the one of each of the network controllers of the first and second nodes are configured to receive downstream data streams.

9. An apparatus for aggregating multiple sources of network data streams into a common feed comprising:
two or more network controllers, said network controllers connected to a network for receiving said network data streams from said network,
two or more inputs, each of said inputs connected to each of said network controllers,
a memory buffer to temporarily store said network data streams from said inputs,
an outlet port capable of transferring network data streams from said memory buffer and a CPU to an output network, and
a CPU connected to said inputs, said memory buffer and said outlet port to transfer said network data streams from said inputs to said memory buffer, and simultaneously transmit said network data streams from said memory buffer to said outlet port.

10. The apparatus of claim 9 wherein the CPU is provided with a version of the Linux operating system modified to support a monitor port and all incoming traffic is redirected to the monitor port.

11. The apparatus of claim 9 wherein the network controllers are configured to received network data streams from Ethernet, Fast Ethernet, FDDI, 1 Gigabit Ethernet, 10 Gigabit Ethernet, and combinations thereof.

12. An apparatus for aggregating multiple sources of network data streams into a common feed comprising:
a first and second node, wherein each of said first and second nodes have
two or more network controllers, said network controllers connected to a network for receiving said network data streams from said network,
two or more inputs, each of said inputs connected to each of said network controllers,
a memory buffer to temporarily store said network data streams from said inputs,
an outlet port capable of transferring network data streams from said memory buffer and a CPU to an output network, and a CPU connected to said inputs, said memory buffer and said outlet port to transfer said network data streams from said inputs to said memory buffer, and simultaneously transmit said network data streams from said memory buffer to said outlet port,
a third node connected to said first and second nodes, wherein said third node has:
two or more inputs, each input connected with one of said outlet ports of said first and second nodes,
a memory buffer to temporarily store network data streams from said inputs,
a final outlet port capable of transferring network data streams from said memory buffer and a CPU to an output network, and
a CPU connected to said inputs, said memory buffer and said final outlet port to transfer said network data streams from said inputs to said memory buffer, and simultaneously transmit said network data streams from said memory buffer to said final outlet port.

13. The apparatus of claim 12 wherein each of the CPUs of the first, second and third nodes are provided with a version of the Linux operating system modified to support a monitor port and all incoming traffic is redirected to the monitor port.

14. The apparatus of claim 12 wherein the network controllers are configured to received network data streams from Ethernet, Fast Ethernet, FDDI, 1 Gigabit Ethernet, 10 Gigabit Ethernet, and combinations thereof.

15. The apparatus of claim 12 wherein the network controllers of the first node are configured to receive upstream network data streams and the network controllers of the second node are configured to receive downstream data streams.

16. The apparatus of claim 12 wherein the one of each of the network controllers of the first and second nodes are configured to receive upstream network data streams and the one of each of the network controllers of the first and second nodes are configured to receive downstream data streams.
